(19) United States
(12) Patent Application Publication
(10) Pub. No.: US 2025/0046827 A1
(43) Pub. Date: Feb. 6, 2025

(54) PHOSPHATE-TOLERANT CORE-SHELL NANOPARTICLES FOR HIGH TEMPERATURE PROTON EXCHANGE MEMBRANE FUEL CELLS AND METHODS FOR MAKING THE SAME

(71) Applicant: Toyota Motor Engineering & Manufacturing North America, Inc., Plano, TX (US)

(72) Inventors: Honghong Lin, Ann Arbor, MI (US); Siwen Wang, Ann Arbor, MI (US); Hongfei Jia, Ann Arbor, MI (US); Chen Ling, Troy, MI (US); Gaohua Zhu, Ann Arbor, MI (US); Liang Wang, Saline, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/365,432

(22) Filed: Aug. 4, 2023

(51) Int. Cl. H01M 4/92; H01M 4/86; H01M 8/1018

(52) U.S. Cl. CPC H01M 4/921; H01M 4/8657; H01M 8/1018; H01M 2004/8689; H01M 2008/1095

(57) ABSTRACT

A cathode catalyst for a nanoparticle catalyst and method of making the same may include creating a nanoparticle. The nanoparticle catalyst may include a shell, wherein the shell may include platinum (Pt). The nanoparticle catalyst may include a core within the shell, wherein the core may include a platinum alloy (Pt-M), where M is a transition metal.

### BACKGROUND

Generally, phosphoric acid poisoning of platinum group catalysts suppress the activity of oxygen reduction reaction (ORR) in high temperature polymer exchange membrane (PEM) fuel cells (e.g., between 80-230° C.). Typically, the poisoning is mainly due to the competitive adsorption of phosphate on the platinum (Pt) surface, which decreases the surface reactive site number.

### BRIEF SUMMARY OF DISCLOSURE

In one example implementation, a method for making a cathode catalyst for a nanoparticle catalyst may include but is not limited to include creating a nanoparticle. The nanoparticle catalyst may include a shell, wherein the shell may include platinum (Pt). The nanoparticle catalyst may include a core within the shell, wherein the core may include a platinum alloy (Pt-M), where M is a transition metal.

One or more of the following example features may be included. The platinum alloy may be a bimetallic platinum alloy. The shell may be in a compressed strain state with the core having a smaller lattice than the shell. The shell may include at least one of Pt—Ag and Pt—Au. M may include at least one of V, Cr, Mn, Fe, Co, Ni, Cu, Zn, Ga, Ru. A ratio of the core may be tuned. A high-temperature polymer exchange membrane fuel cell between 80-230 degrees Celsius may be included, wherein the nanoparticle catalyst may be a catalyst for the high-temperature polymer exchange membrane fuel cell.

In another example implementation, a cathode catalyst may include but is not limited to a nanoparticle catalyst, wherein the nanoparticle catalyst may include a shell, wherein the shell includes platinum (Pt). The nanoparticle catalyst may further include a core within the shell, wherein the core may include a platinum alloy (Pt-M), where M is a transition metal.

One or more of the following example features may be included. The platinum alloy may be a bimetallic platinum alloy. The shell may be in a compressed strain state with the core having a smaller lattice than the shell. The shell may include at least one of Pt—Ag and Pt—Au. M may include at least one of V, Cr, Mn, Fe, Co, Ni, Cu, Zn, Ga, Ru. A ratio of the core may be tuned. A high-temperature polymer exchange membrane fuel cell between 80-230 degrees Celsius may be included, wherein the nanoparticle catalyst may be a catalyst for the high-temperature polymer exchange membrane fuel cell.

In another example implementation, a cathode catalyst may include but is not limited to a nanoparticle catalyst, wherein the nanoparticle catalyst may include a shell, wherein the shell includes platinum (Pt). The nanoparticle catalyst may further include a core within the shell, wherein the core may include a platinum alloy (Pt-M), where M is a transition metal. A high-temperature polymer exchange membrane fuel cell between 80-230 degrees Celsius may be included, wherein the nanoparticle catalyst may be a catalyst for the high-temperature polymer exchange membrane fuel cell.

One or more of the following example features may be included. The platinum alloy may be a bimetallic platinum alloy. The shell may be in a compressed strain state with the core having a smaller lattice than the shell. The shell may include at least one of Pt—Ag and Pt—Au. M may include at least one of V, Cr, Mn, Fe, Co, Ni, Cu, Zn, Ga, Ru. A ratio of the core may be tuned.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example flowchart of a creation process according to one or more example implementations of the disclosure;

FIG. 2 is an example diagrammatic view of a core/shell nanoparticle catalyst created by a creation process according to one or more example implementations of the disclosure;

FIG. 3 are example charts of an example ORR activity enhancement due to an increased O site retention of a catalyst's surface according to one or more example implementations of the disclosure; and

FIG. 4 are example charts of a calculation of the binding energy of phosphate (H₂PO₄) with Pt₁M₁(111)/Pt(111)skin surface and Pt₁M₁(111) alloy surface according to one or more example implementations of the disclosure.

Like reference symbols in the various drawings may indicate like elements.

### DETAILED DESCRIPTION

Generally, phosphoric acid poisoning of platinum group catalysts suppress the activity of oxygen reduction reaction (ORR) in high temperature polymer exchange membrane (PEM) fuel cells (e.g., between 80-230° C.). Typically, the poisoning is mainly due to the competitive adsorption of phosphate on the platinum (Pt) surface, which decreases the surface reactive site number.

Bimetallic catalysts PtM (e.g., where M=Fe, Co, Ni, etc.) were reported in the past to improve oxygen reduction reactions in “low”-temperature polymer exchange membrane fuel cells (LT-PEMFCs) (e.g., 60-80° C.), where the Pt—O binding strength is optimized to facilitate the ORR kinetics. However, the high ORR activity cannot be translated from LT-PEMFCs to high-temperature polymer exchange membrane fuel cells (HT-PEMFCs) (e.g., between 80-230° C.) because the phosphoric acid in the HT-PEMFCs suppress the ORR activity via phosphoric acid adsorption. As such, the same structure used in the LT-PEMFCs could not be used in HT-PEMFCs. Therefore, as will be discussed the present disclosure discusses creating a series (e.g., use of different compositions with the same ORR) of core/shell catalysts to reduce the poisoning from phosphoric acid to achieve a high ORR activity in phosphoric acid. The present disclosure, therefore, discloses a core/shell nanocrystal catalyst with a PtM core and Pt—Ag or Pt—Au shell in a compressed strain state used on the cathode side of a HT-PEMFC to improve ORR activity. Thus, by creating a shell with a weaker binding strength with phosphoric acid, the phosphoric acid adsorption on the catalyst surface is reduced. Such a modification may increase the surface reactive sites and improve the ORR activity in phosphoric acid.

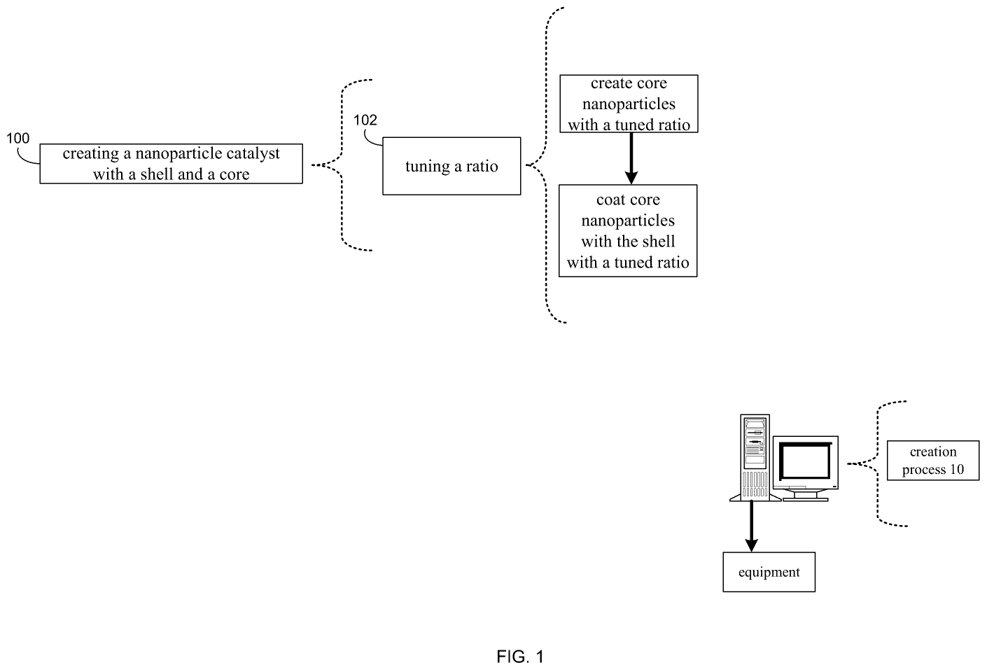

As discussed above and referring also at least to the example implementations of FIGS. 1-4, creation process 10 may create a cathode catalyst for a nanoparticle catalyst, which may include creating 100 the nanoparticle catalyst. The nanoparticle catalyst may include a shell, wherein the shell may include platinum (Pt). The nanoparticle catalyst may include a core within the shell, wherein the core may include a platinum alloy (Pt-M), where M is a transition metal.

It will be appreciated that any standard nanoparticle catalyst creation equipment, as well as any other necessary equipment, may be used singly or in any combination with creation process 10, which may be operatively connected to a computing device, such as the computing device shown in FIG. 1, to obtain their instructions. In one or more example implementations, the respective flowcharts may be manually-implemented, computer-implemented, or a combination thereof. As will be discussed in greater detail, for the nanoparticle synthesis, the sequence may be (1) create the core nanoparticles with a tuned ratio, and (2) coat the nanoparticles with the shell with a tuned ratio. The nanoparticles are typically made via a colloidal synthesis method. In a reaction flask with inert gas protection, the metal precursors are mixed with a desired ratio, in the presence of the solvent and reducing agent. The mixture is then heated to the range of, e.g., 80-350 degree C. to reduce the metal precursors, forming metallic nanoparticles. The nanoparticles would be precipitated via centrifugation, and then washed with mixture solvents several times. The obtained nanoparticles will then be loaded onto high surface area carbon support to make the carbon-supported metal nanoparticle catalyst.

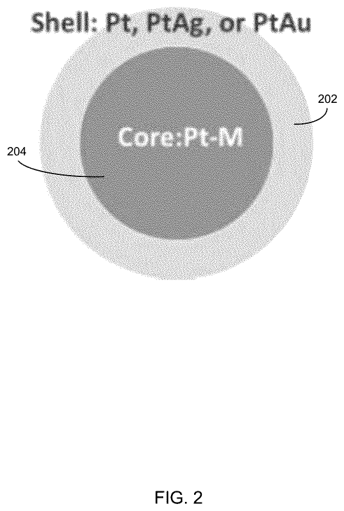

In some implementations, creation process 10 may create a cathode catalyst for a nanoparticle catalyst, which may include creating 100 the nanoparticle catalyst. For instance, and referring to the example implementation of FIG. 2, an example structure of a nanoparticle catalyst (e.g., nanoparticle catalyst 200) is shown. In some implementations, the nanoparticle catalyst created 100 by creation process 10 may include a shell. For instance, and still referring to FIG. 2, nanoparticle catalyst 200 is shown with a shell (e.g., shell 202). In some implementations, shell 202 may include at least one of platinum (Pt), Pt—Ag and Pt—Au. That is, shell 202 may include Pt, Pt—Ag, or Pt—Au (or combinations thereof). In some implementations, shell 202 may be a smooth, nonporous shell. “Smooth, non-porous shell” may be used to distinguish the PtM/Pt catalyst from the previous PtM catalyst. The reason is that PtM catalyst may evolve to a PtM/Pt catalyst with a Pt skeleton surface after M dissolution in acid. To form “smooth, non-porous shell”, the synthesis will be controlled to form a Pt layer on the catalyst surface before putting the catalyst to the acidic testing condition.

In some implementations, the nanoparticle catalyst created 100 by creation process 10 may include a core within the shell. For instance, and still referring to FIG. 2, nanoparticle catalyst 200 is shown with a core (e.g., core 204). In the example, core 204 may include a platinum alloy (Pt-M), where M is a transition metal. That is, in some implementations, core 204 may include Pt-M, where M may include at least one of V, Cr, Mn, Fe, Co, Ni, Cu, Zn, Ga, Ru As such, core 204 may be a bimetallic platinum alloy (Pt-M₁, M₁=the first-row transition metals (V, Cr, Mn, Fe, Co, Ni, Cu, Zn, Ga, Ru).

In some implementations, a high-temperature polymer exchange membrane fuel cell between 80-230° C. may be included, wherein the nanoparticle catalyst may be a catalyst for the high-temperature polymer exchange membrane fuel cell. For instance, nanoparticle catalyst 200 may be used as the cathode catalyst in a fuel cell (e.g., a “high”-temperature polymer exchange membrane fuel cells (HT-PEMFCs with a temperature between 80-230° C.) by, in some implementations and at least in part, using phosphoric acid or organic phosphonic acid as the electrolyte in the cathode catalyst layer, thereby addressing the issue of having the phosphoric acid in the HT-PEMFCs suppress the ORR activity via phosphoric acid adsorption.

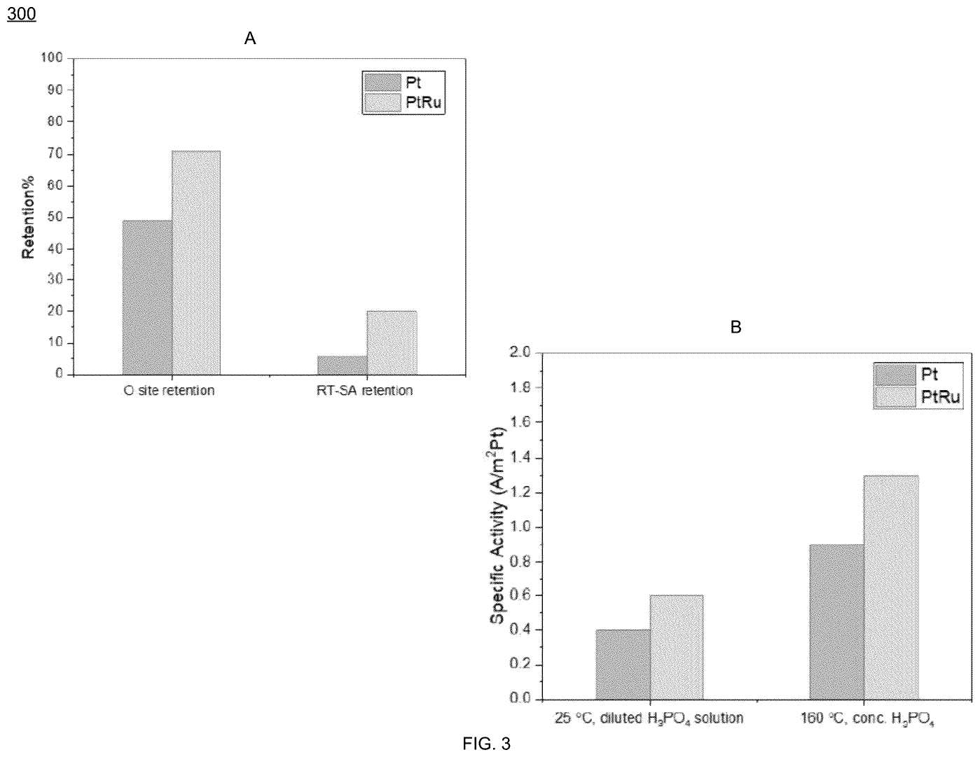

Referring also at least to the example implementation of FIG. 3, there are shown example charts 300 of the ORR activity enhancement due to the increased O site retention of the catalyst's surface. Chart A is the O site (active site) retention and room temperature (RT) ORR activity retention, retention %=(value with H₃PO₄/value without H₃PO₄)*100%; and chart B is the ORR activity comparison in diluted H₃PO₄ at 25° C. and concentrated H₃PO₄ at 160° C. It was discovered that a catalyst's surface with a better resistance to phosphoric acid adsorption can show higher ORR activity in phosphoric acid. Therefore, in the example catalyst design of core/shell 200, the function of shell 202 is to prevent phosphoric acid from blocking the active sites of the catalyst surface. With a weaker binding energy using phosphate, the core/shell catalyst will retain more active sites on the surface to achieve a higher ORR activity in phosphoric acid. By assuming that a weaker interaction with phosphoric acid can reduce phosphoric acid coverage on the catalyst surface, the nanoparticle catalyst may be created 100 by selecting the compositions that have a weaker binding energy with phosphoric acid in the preliminary calculation.

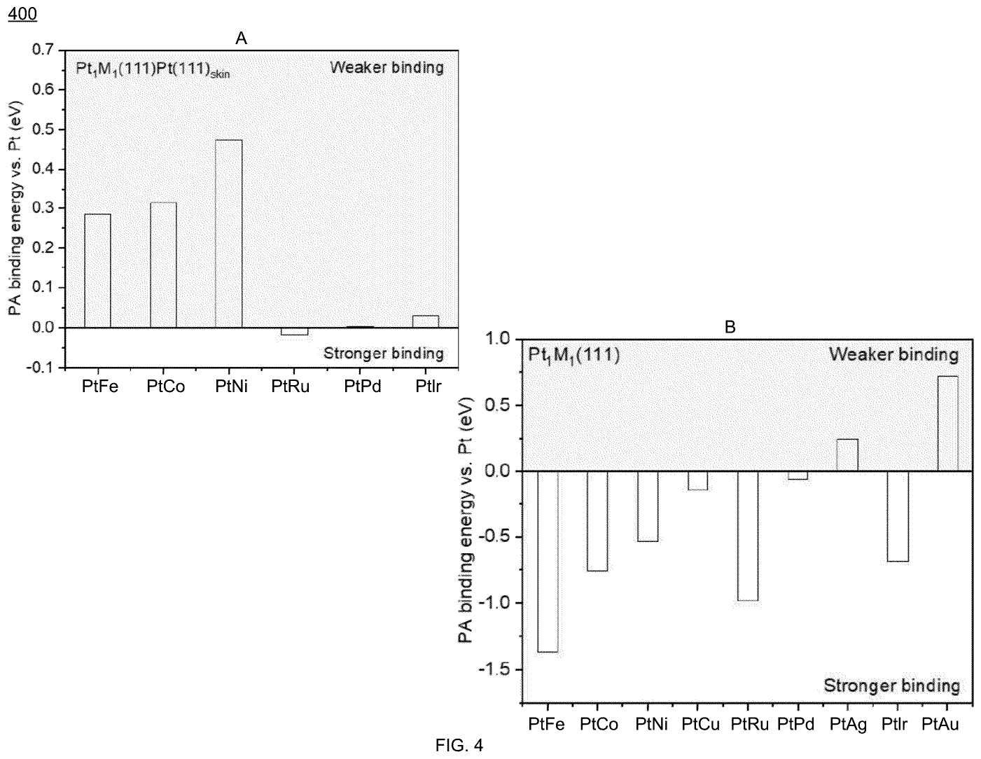

For instance, and referring at least to the example implementation of FIG. 4, there are shown charts 400 of a calculation of the binding energy of phosphate (H₂PO₄) with Pt₁M₁ (111)/Pt(111)skin surface and Pt₁M₁ (111) alloy surface. FIG. 4 thus shows the theoretical calculation of chart A as the binding energy of phosphate (H₂PO₄) with Pt₁M₁ (111)/Pt(111)skin surface and chart B as Pt₁M₁ (111) alloy surface. A more positive binding energy of y axis suggests a weaker binding of phosphoric acid on the catalyst surface than Pt(111). Pt₁M₁(111)/Pt(111)ₛₖᵢₙ (M=Fe, Co, Ni, Ru, Ir) and Pt₁M₁(111) (M=Ag, Au) show more positive binding energy in the theoretical calculation, corresponding to weaker adsorption of phosphoric acid on these surfaces.

In some implementations, the shell may be in a compressed strain state with the core having a smaller lattice than the shell. For instance, the Pt—Ag or Pt—Au shell may be in a compressed strain state due to the Pt-M core having a smaller lattice than the Pt—Ag or Pt—Au shell. In a PtM/Pt core/shell nanoparticle, where M is a smaller atom than Pt, the lattice parameter of the pure Pt shell is found to be smaller than that of the bulk Pt, in this way, the core exerts a compressive strain to the Pt shell. On the other hand, for a PtAu/Pt core/shell nanoparticle, where Au is larger than Pt, the lattice parameter of the pure Pt shell is found to be larger than that of the bulk Pt, in this way, the core exerts a tensile strain to the Pt shell. With the shell being in the compressed strain state, this weakens OH adsorption on the shell and thereby enhances ORR activity and stability thereof in the presence of phosphoric acid or organic phosphonic acid in a HT-PEMFC. Because some shell composition does not provide an optimal binding energy to achieve a high ORR activity, the nanoparticle catalyst may be created 100 by choosing to have a core component rather than a “uniform” Pt, Pt—Ag alloy, or Pt—Au alloy nanoparticle catalyst. Uniform may generally mean that the core and the shell have the same composition, so the core and shell have different compositions.

In some implementations, the creation process 10 may tune 102 a ratio of the core. For instance, and referring again to FIG. 1, by alloying Pt with a smaller transition metal, the core will exert a compressive strain onto the shell, which strain will allow improved ORR activity. By tuning 102 the ratio of the core, an optimal strain and increase of the ORR activity may be achieved. Different elements, with different Pt:M ratios, can be adjusted in the synthesis. Since the strain is introduced by the lattice difference of the core and the shell, tuning the elements and the ratios of the core affects the strain experienced by the shell. When the nanoparticle is made in the lab, it may proceed in the sequence of making the core with a ratio, making the shell with a ratio, and then getting a core/shell nanoparticle with the desired ratio in the core and the shell.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A cathode catalyst comprising:
a nanoparticle catalyst, wherein the nanoparticle catalyst includes:
a shell, wherein the shell includes platinum (Pt);
a core within the shell, wherein the core includes a platinum alloy (Pt-M), where M is a transition metal.

2. The cathode catalyst of claim 1, wherein the platinum alloy is a bimetallic platinum alloy.

3. The cathode catalyst of claim 1, wherein the shell is in a compressed strain state with the core having a smaller lattice than the shell.

4. The cathode catalyst of claim 1, wherein the shell includes Pt—Ag.

5. The cathode catalyst of claim 1, wherein the shell includes Pt—Au.

6. The cathode catalyst of claim 1, wherein M includes at least one of V, Cr, Mn, Fe, Co, Ni, Cu, Zn, Ga, Ru.

7. The cathode catalyst of claim 1 further comprising a high-temperature polymer exchange membrane fuel cell between 80-230 degrees Celsius, wherein the nanoparticle catalyst is a catalyst for the high-temperature polymer exchange membrane fuel cell.

8. A cathode catalyst comprising:
a nanoparticle catalyst, wherein the nanoparticle catalyst includes:
a shell, wherein the shell includes platinum (Pt);
a core within the shell, wherein the core includes a platinum alloy (Pt-M), where M is a transition metal; and
a high-temperature polymer exchange membrane fuel cell, wherein the nanoparticle catalyst is a catalyst for the high-temperature polymer exchange membrane fuel cell.

9. The cathode catalyst of claim 8, wherein the platinum alloy is a bimetallic platinum alloy.

10. The cathode catalyst of claim 8, wherein the shell is in a compressed strain state with the core having a smaller lattice than the shell.

11. The cathode catalyst of claim 8, wherein the shell includes Pt—Ag.

12. The cathode catalyst of claim 8, wherein the shell includes Pt—Au.

13. The cathode catalyst of claim 8, wherein M includes at least one of V, Cr, Mn, Fe, Co, Ni, Cu, Zn, Ga, Ru.

14. The cathode catalyst of claim 1, wherein the high-temperature polymer exchange membrane fuel cell is between 80-230 degrees Celsius.

15. A method comprising:
creating a nanoparticle catalyst, wherein the nanoparticle catalyst includes:
a shell, wherein the shell includes platinum (Pt);
a core within the shell, wherein the core includes a platinum alloy (Pt-M), where M is a transition metal.

16. The method of claim 15, wherein the platinum alloy is a bimetallic platinum alloy.

17. The method of claim 15, wherein the shell is in a compressed strain state with the core having a smaller lattice than the shell.

18. The method of claim 15, wherein the shell includes at least one of Pt—Ag and Pt—Au.

19. The method of claim 15, wherein M includes at least one of V, Cr, Mn, Fe, Co, Ni, Cu, Zn, Ga, Ru.

20. The method of claim 15 further comprising tuning a ratio of the core.
